(19) United States
(12) Patent Application Publication
(10) Pub. No.: US 2019/0253607 A1
(43) Pub. Date: Aug. 15, 2019

(54) OBJECT TRACKING AUTOFOCUS

(71) Applicant: QUALCOMM Incorporated, San Diego, CA (US)

(72) Inventors: Richard Chen, Arcadia, CA (US); Wen-Chun Feng, Taipei (TW); Mian Li, Shenzhen (CN)

(21) Appl. No.: 15/989,089

(22) Filed: May 24, 2018

Related U.S. Application Data
(60) Provisional application No. 62/631,121, filed on Feb. 15, 2018.

(51) Int. Cl. H04N 5/232; H04N 5/225

(52) U.S. Cl. CPC H04N 5/23212; H04N 5/23293; H04N 5/23216; H04N 5/2257

(57) ABSTRACT

Aspects of the present disclosure relate to systems and methods for performing autofocus. An example device may include a processor and a memory. The processor may be configured to receive a first image captured by a camera, determine a first ROI for the first image, receive a second image captured by the camera after capturing the first image, determine a second ROI for the second image, compare the first ROI and the second ROI, and delay a determination of a final focal length based on the comparison of the first ROI and the second ROI.

### CROSS-REFERENCE TO RELATED APPLICATIONS

This patent application claims priority to U.S. Provisional Patent Application No. 62/631,121 entitled “OBJECT TRACKING AUTOFOCUS” filed on Feb. 15, 2018, which is assigned to the assignee hereof. The disclosure of the prior application is considered part of and are incorporated by reference in this patent application.

### TECHNICAL FIELD

This disclosure relates generally to systems and methods for image capture devices, and specifically to autofocus operations.

### BACKGROUND

Devices including or coupled to one or more digital cameras use a camera lens to focus incoming light onto a camera sensor for capturing digital images. The curvature of a camera lens places objects in a range of depth of the scene in focus. Portions of the scene closer or further than the range of depth may be out of focus, and therefore appear blurry in a captured image. The distance of the camera lens from the camera sensor (the “focal length”) is directly related to the distance of the range of depth for the scene from the camera sensor that is in focus (the “focus distance”). Devices may adjust the focal length, such as by moving the camera lens to adjust the distance between the camera lens and the camera sensor, and thereby adjust the focus distance.

Many devices automatically determine the focal length for a region of interest (ROI). For example, a user may touch an area of a preview image provided by the device (such as a person or landmark in the previewed scene) to indicate the ROI. In another example, the device may identify an object or face, and determine a ROI for the identified object or face. In response, the device may automatically perform an autofocus (AF) operation to adjust the focal length so that the ROI is in focus. The device may then use the determined focal length for subsequent image captures (including generating a preview).

One problem with conventional AF operations is that the ROI is fixed once determined, even if the ROI changes (such as a face or object moving outside of or changing depths in the ROI. For example, a face may be identified in a preview, and the device may determine a fixed ROI including the face to be used for performing an AF operation. If the face moves out of the ROI or changes depth, the ROI does not change. As a result, a focal length to originally place the face or object in focus and determined through the AF operation may not remain appropriate for the face or object.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for performing autofocus. In some example implementations, a device may include a processor and a memory. The processor may be configured to receive a first image captured by a camera, determine a first region of interest (ROI) for the first image, receive a second image captured by the camera after capturing the first image, determine a second ROI for the second image, compare the first ROI and the second ROI, and delay a determination of a final focal length based on the comparison of the first ROI and the second ROI.

In another example, a method is disclosed. The example method includes receiving a first image captured by a camera, determining a first ROI for the first image, receiving a second image captured by the camera after capturing the first image, determining a second ROI for the second image, comparing the first ROI and the second ROI, and delaying a determination of a final focal length based on the comparison of the first ROI and the second ROI.

In a further example, a non-transitory computer-readable medium is disclosed. The non-transitory computer-readable medium may store instructions that, when executed by a processor, cause a device to perform operations including receiving a first image captured by a camera, determining a first ROI for the first image, receiving a second image captured by the camera after capturing the first image, determining a second ROI for the second image, comparing the first ROI and the second ROI, and delaying a determination of a final focal length based on the comparison of the first ROI and the second ROI.

In another example, a device is disclosed. The device includes means for receiving a first image captured by a camera, means for determining a first ROI for the first image, means for receiving a second image captured by the camera after capturing the first image, means for determining a second ROI for the second image, means for comparing the first ROI and the second ROI, and means for delaying a determination of a final focal length based on the comparison of the first ROI and the second ROI.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is a block diagram of an example device for performing AF.

FIG. 2 is a depiction of an example correlation between focal length and contrast for contrast detection AF.

FIG. 3A is a depiction of a camera lens at a focal length so that an object is in focus.

FIG. 3B is a depiction of a camera lens at too long of a focal length so that the object is out of focus.

FIG. 3C is a depiction of a camera lens at too short of a focal length so that the object is out of focus.

FIG. 4 is a depiction of an example correlation between focal length and phase difference for phase difference AF.

FIG. 5 is an illustrative flow chart depicting an example operation for performing hybrid AF for a ROI.

FIG. 6A is a depiction of an example change in location of an ROI.

FIG. 6B is a depiction of an example size adjustment of an ROI.

FIG. 7 is an illustrative flow chart depicting an example operation for deciding when to determine a final focal length when an object or face is moving.

FIG. 8 is an illustrative flow chart depicting an example operation for determining a final focal length when the object or face is stable.

### DETAILED DESCRIPTION

Aspects of the present disclosure may be used for performing AF. The focal length determined during AF may be based on a ROI. For conventional AF based on a ROI, the ROI is static (does not move within the scene). For example, when an object or face is identified by a device, the device determines a fixed or static ROI including the identified object or face. The ROI may no longer include the face or object if the face or object moves laterally relative to the camera, and the ROI may be too small or too large for the object or face if the object or face changes depth from the camera. As a result, a determined focal length for the fixed ROI may not remain appropriate for the moving face or object.

With scene changes (such as an object or face moving in an ROI), the focal length may include a focal length error. The focal length error may be caused in part by latency or delays in performing the AF operation, which may span a sizable number of image frames (and corresponding scene changes) after the ROI is fixed. As a result, the movement of an object or face may be significant before the AF operation is complete and a focal length is determined. In some aspects of the present disclosure, the example AF operations may be quicker than conventional AF operations. In additional or alternative aspects of the present disclosure, the example AF operations may allow for object or face tracking (for which an ROI may move) instead of requiring a fixed ROI.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device (such as a security system with one or more cameras, smartphones, tablets, laptop computers, digital video and/or still cameras, web cameras, and so on) configured to or capable of capturing images or video. While described below with respect to a device having or coupled to one camera, aspects of the present disclosure are applicable to devices having any number of cameras (including no cameras, where a separate device is used for capturing images or video which are provided to the device), and are therefore not limited to devices having one camera. Aspects of the present disclosure are applicable for capturing still images as well as for capturing video, and may be implemented in devices having or coupled to cameras of different capabilities (such as a video camera or a still image camera).

The term “device” is not limited to one or a specific number of physical objects (such as one smartphone, one camera controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects.

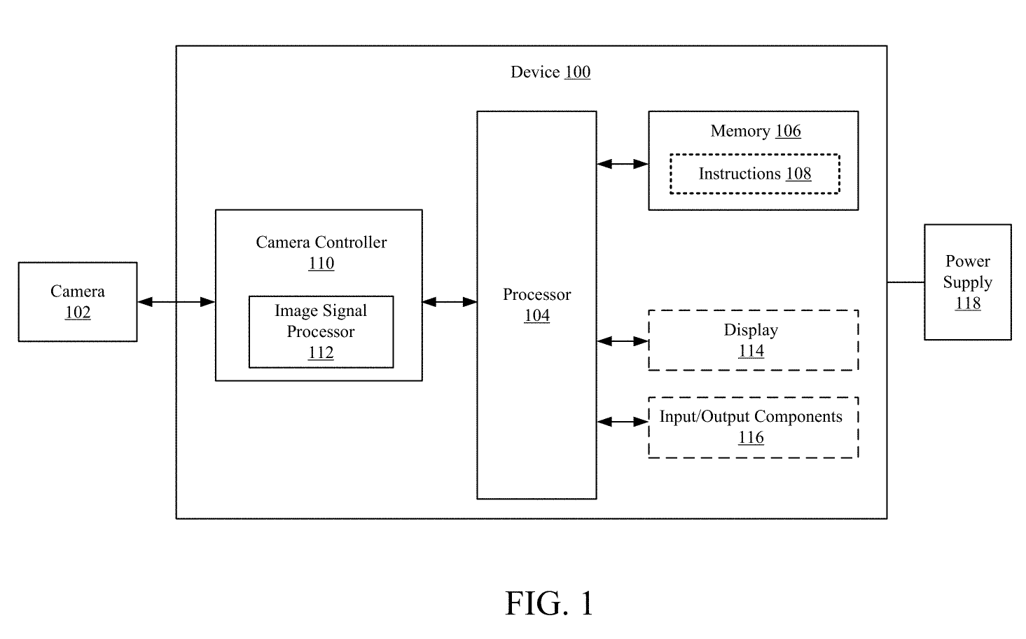

FIG. 1 is a block diagram of an example device 100 for performing an AF operation. The example device 100 may include or be coupled to a camera 102, a processor 104, a memory 106 storing instructions 108, and a camera controller 110. The device 100 may optionally include (or be coupled to) a display 114 and a number of input/output (I/O) components 116. The device 100 may include additional features or components not shown. For example, a wireless interface, which may include a number of transceivers and a baseband processor, may be included for a wireless communication device. The device 100 may include or be coupled to additional cameras other than the camera 102. The disclosure should not be limited to any specific examples or illustrations, including the example device 100.

The camera 102 may be capable of capturing individual image frames (such as still images) and/or capturing video (such as a succession of captured image frames). The camera 102 may include a single camera sensor and camera lens, or be a dual camera module or any other suitable module with multiple camera sensors and lenses. The memory 106 may be a non-transient or non-transitory computer readable medium storing computer-executable instructions 108 to perform all or a portion of one or more operations described in this disclosure. The device 100 may also include a power supply 118, which may be coupled to or integrated into the device 100.

The processor 104 may be one or more suitable processors capable of executing scripts or instructions of one or more software programs (such as instructions 108) stored within the memory 106. In some aspects, the processor 104 may be one or more general purpose processors that execute instructions 108 to cause the device 100 to perform any number of functions or operations. In additional or alternative aspects, the processor 104 may include integrated circuits or other hardware to perform functions or operations without the use of software. While shown to be coupled to each other via the processor 104 in the example of FIG. 1, the processor 104, the memory 106, the camera controller 110, the optional display 114, and the optional I/O components 116 may be coupled to one another in various arrangements. For example, the processor 104, the memory 106, the camera controller 110, the optional display 114, and/or the optional I/O components 116 may be coupled to each other via one or more local buses (not shown for simplicity).

The display 114 may be any suitable display or screen allowing for user interaction and/or to present items (such as captured images, video, or a preview image) for viewing by a user. In some aspects, the display 114 may be a touch-sensitive display. The I/O components 116 may be or include any suitable mechanism, interface, or device to receive input (such as commands) from the user and to provide output to the user. For example, the I/O components 116 may include (but are not limited to) a graphical user interface, keyboard, mouse, microphone and speakers, and so on. The display 114 and/or the I/O components 116 may provide a preview image to a user and/or receive a user input for adjusting one or more settings of the camera 102 (such as selecting and/or deselecting a region of interest of a displayed preview image for an AF operation).

The camera controller 110 may include an image signal processor 112, which may be one or more image signal processors to process captured image frames or video provided by the camera 102. In some example implementations, the camera controller 110 (such as the image signal processor 112) may also control operation of the camera 102 (such as performing as AF operation). In some aspects, the image signal processor 112 may execute instructions from a memory (such as instructions 108 from the memory 106 or instructions stored in a separate memory coupled to the image signal processor 112) to process image frames or video captured by the camera 102 and/or control the camera 102. In other aspects, the image signal processor 112 may include specific hardware to process image frames or video captured by the camera 102. The image signal processor 112 may alternatively or additionally include a combination of specific hardware and the ability to execute software instructions.

Many devices use contrast detection autofocus (CDAF) to determine a focal length. For CDAF, a device measures the contrast, which is the difference in pixel intensity between neighboring pixels. The difference in intensity between neighboring pixels for a blurry image is lower than the difference in intensity between neighboring pixels for an in focus image. In performing CDAF, a device may attempt to determine a focal length that causes a maximum contrast measurement.

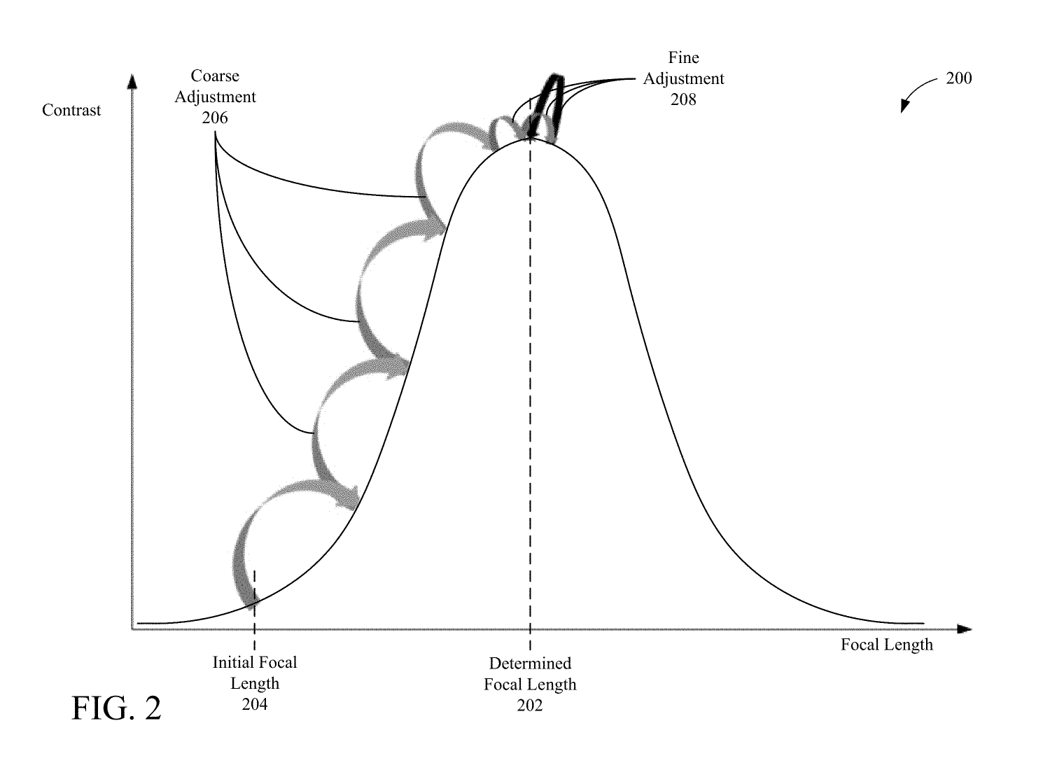

FIG. 2 is a depiction 200 of an example correlation between focal length and contrast measurements for CDAF. As shown, the correlation is parabolic/second order. The exact curvature may differ, and the depiction 200 is for illustrative purposes only. For example, the correlation may be expressed in general by a second order equation y=ax²+bx+c, where the contrast is y, the focal length is x, the curvature of the parabola is indicated by a, the slope of the parabola is indicated by b, and the offset of the parabola is indicated by c. The focal length 202 to be determined is based on the contrast approaching or being at a maximum, which is the vertex of the parabola. For example, the vertex is −b/2a for the above second order equation.

For CDAF, a device (such as device 100) may iteratively perform one or more coarse adjustments 206 to the initial focal length 204, and then iteratively perform one or more fine adjustments 208 to the focal length. The device 100 may therefore perform an iterative process of measuring the contrast, adjusting the focal length, and again measuring the contrast until the vertex in contrast is found (and therefore the focal length 202 is determined). The coarse adjustments 206 are larger movements of the camera lens than fine adjustments 208 for when the initial focal length 204 is a sizable distance from the determined focal length 202 (such as greater than a threshold distance from the determined focal length 202). For example, the slope of the parabola may be increasing over successive focal lengths, and/or the slope of the parabola may be greater than a threshold. In this manner, the device 100 may determine that the determined focal length 202 is still a distance from the current focal length so that another coarse adjustment 206 may be performed.

The device 100 may determine to switch from coarse adjustments 206 to fine adjustments 208 when approaching the focal length 202 (such as the vertex or close to the vertex of the parabola curve). For example, the device 100 may determine to switch between adjustment types when the slope of the parabola begins to decrease across adjusted focal lengths, the slope is less than a threshold, the change in contrast is less than a threshold, and so on. In performing fine adjustments 208, the device 100 may move the camera lens less than for coarse adjustments 206 to prevent sizably overshooting focal length 202 (sizably passing the vertex of the contrast curve). The device 100 may continue to move the camera lens in one direction using fine adjustments 208 until the measured contrast decreases, indicating that the vertex of the parabola curve (and the maximum contrast) is overshot. The device 100 may then move the camera lens between the last focal length and current focal length to determine focal length 202.

In performing CDAF for a ROI, the ROI remains static or fixed while determining the focal length. However, recursively adjusting the focal length and measuring the contrast may require an amount of time during which the scene contents of the ROI may change. For example, an object or face may change position or depth while the ROI is fixed.

Another AF operation that may be performed to determine a focal length is phase difference autofocus (PDAF). For PDAF, two instances of light reflected from an object in the scene passes through different portions of the camera lens. If the two instances of light align on the camera sensor after passing through the camera lens, the scene is determined to be in focus for image capture. If the two instances of light hit the camera sensor at different locations, the scene is determined to be out of focus.

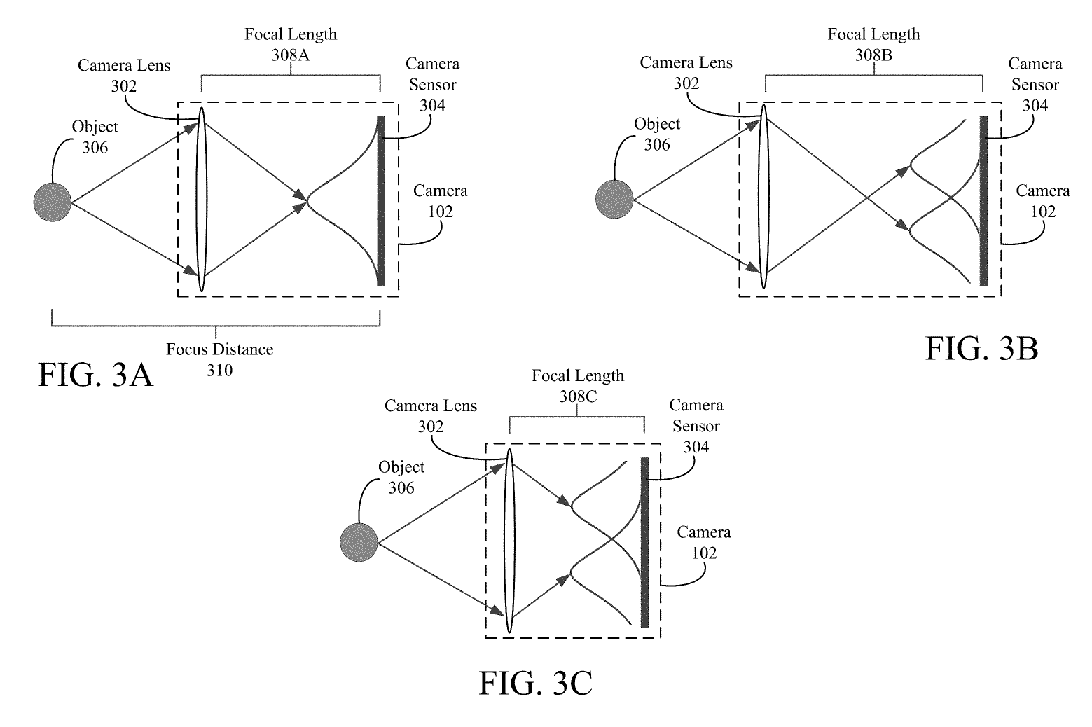

FIG. 3A is an example depiction of the camera 102 from the device 100 with a camera lens 302 at a focal length 308A (from the camera sensor 304) so that an object 306 is in focus at focus distance 310. FIG. 3B is a depiction of the camera 102 from the device 100 with the camera lens 302 at too long of a focal length 308B so that an object 306 is out of focus. FIG. 3C is a depiction of the camera 102 from the device 100 with the camera lens 302 at too short of a focal length 308C so that an object 306 is out of focus. In some example implementations, the camera 102 includes an actuator (not shown) to move the camera lens 302 toward or away from the camera sensor 304, thus adjusting the focal length (and therefore the focus distance).

For PDAF, the device 100 may measure the phase difference between the two instances hitting the camera sensor 304. For example, the phase difference may be a distance (such as the number of pixels) between the two instances hitting the camera sensor 304. In FIG. 3A, the phase difference is zero because the two instances align on the camera sensor 304. In FIGS. 3B and 3C, the PD is greater than and less than zero, respectively, because the two instances do not align on the camera sensor 304.

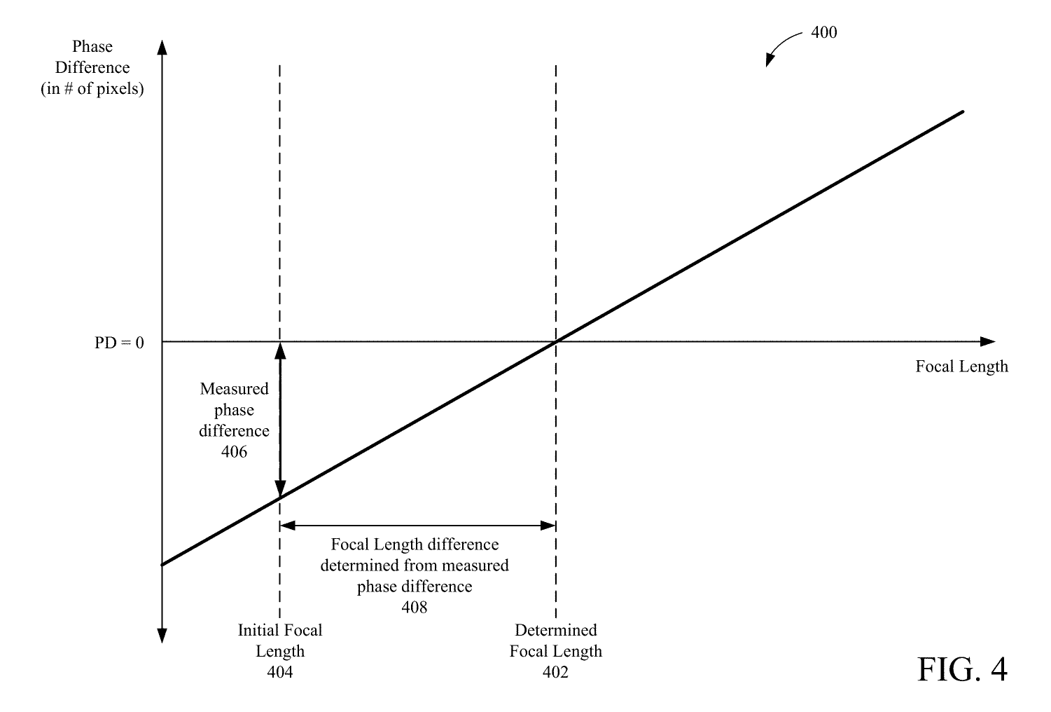

FIG. 4 is a depiction 400 of an example correlation between a focal length and a phase difference for PDAF. As illustrated, the correlation is linear. If the phase difference 406 is measured for an initial focal length 404, the device 100 may determine the focal length difference 408 based on the slope and the offset of the phase difference line to place the camera lens 302 at the determined focal length 402 where the phase difference is zero or close to zero. The correlation (such as the slope and the offset) for a camera may be known. As a result, the device 100 may determine the focal length 402 from one measured phase difference (such as the measured phase difference 406). As compared to CDAF, the amount of time for performing AF may be reduced. For example, a PDAF operation may be performed every frame capture in some instances while a CDAF operation is performed over multiple frame captures

For PDAF, the camera sensor 304 of the camera 102 includes photodiodes (PDs, such as Avalanche PDs) distributed across the sensor for measuring light intensity. The PDs of the camera sensor associated with an identified ROI are used in performing PDAF. For example, the PDs measuring light intensity for light reflected by the portion of the scene corresponding with the ROI are used in performing PDAF. In some example implementations, the camera sensor 304 may be a dual pixel (2PD) camera sensor in which each pixel of the camera sensor includes an associated PD for measuring light intensity. In this manner, the resolution of measured light is the same as the resolution for a captured image. In some other example implementations, the camera sensor 304 may include less PDs than the number of pixels to reduce cost and design complexity. For example, a PD may exist for every m pixel×n pixel of the camera sensor 304, where m and n are integers greater than 1.

As the number of PDs for a camera sensor 304 decreases, the resolution of light intensity measurements decreases. As a result, the accuracy in determining the focal length 402 may decrease. For example, a 2×1 and other sparse sensors may have less accuracy in determining the focal length 402 than a 2PD sensor, as the resolution of measured light intensities for a ROI is less for the 2×1 and other sparse sensors than for the 2PD sensor. As a result, a 2PD sensor may determine a focal length using PDAF with the same accuracy as CDAF. However, sparser sensors may determine a focal length using PDAF with less accuracy than CDAF.

In some aspects of the present disclosure, the device 100 may perform hybrid AF, combining aspects of CDAF and PDAF, to determine a focal length. In this manner, the device 100 may determine the focal length with the accuracy of CDAF but faster than conventional CDAF. In some example implementations, PDAF may be used to determine a range of focal lengths for which to perform CDAF. In bounding CDAF to a smaller range of focal lengths than for conventional CDAF, determining the focal length may be quicker than if performing conventional CDAF as less iterations of adjusting the focal length and measuring the contrast may be performed. While a 2PD sensor may be used to perform PDAF exclusively in determining a focal length, a 2PD sensor may also be used to perform hybrid AF. The present disclosure should not be limited to a specific number or range of PDs for a sensor, and should not be limited to specific types of sensors or PDs. Additionally, while hybrid AF is described in determining a focal length, the device 100 may perform multiple AF operations, such as CDAF and a hybrid AF. For example, the device 100 may perform multiple AF operations sequentially in order to compare the results for consistency and accuracy.

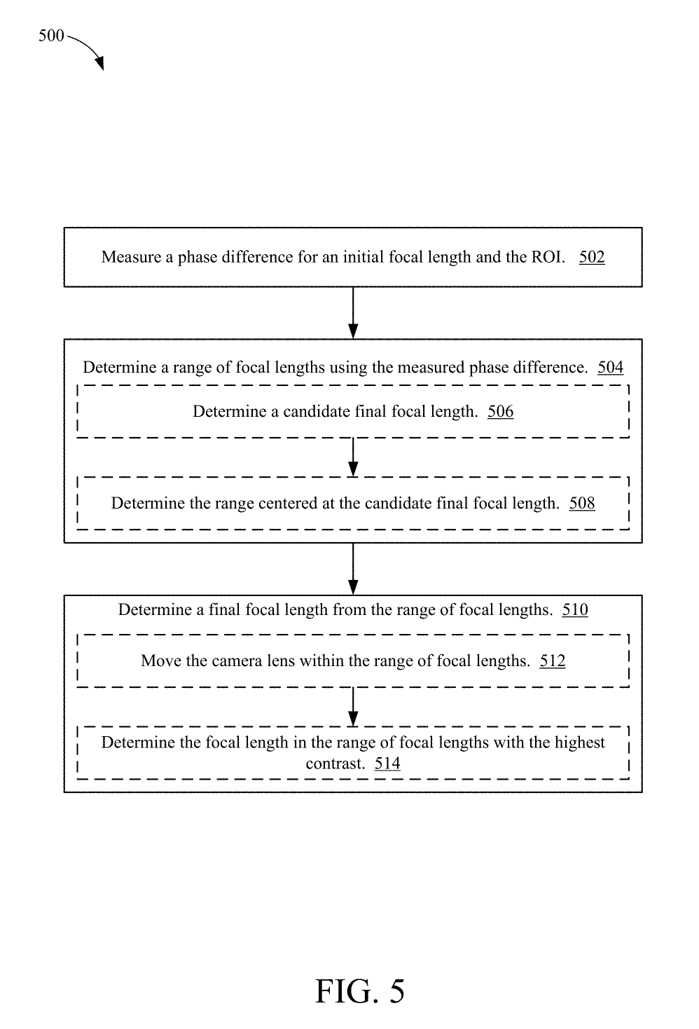

FIG. 5 is an illustrative flow chart depicting an example operation 500 for performing a hybrid AF operation for a ROI. While the following examples and processes are described as being performed by the device 100 (such as the processor 104, the camera controller 110, and/or the image signal processor 112), other devices or configurations may be used in performing one or more of the examples and processes. The present disclosure should not be limited to a specific device or configuration for performing aspects of the present disclosure.

Beginning at 502, the device 100 may measure a phase difference for an initial focal length and an identified ROI (such as an ROI generated to include a face or object). Measuring the phase difference in step 502 may be the same as measuring a phase difference during PDAF. The device 100 may then determine a range of focal lengths using the measured phase difference (504). In some example implementations, the device 100 may determine a candidate final focal length (506). For example, using the measured phase difference for the initial focal length (such as the measured phase difference 406 for initial focal length 404 in FIG. 4), the device may use PDAF to attempt to determine a focal length from the correlation of focal length to phase difference as the candidate final focal length (such as attempting to determine focal length 402 in FIG. 4). Since the resolution of measured light intensities may not be sufficient to accurately determine focal length 402 (causing error in measuring the phase difference for the ROI), the determined candidate focal length may not be the same as focal length 402. However, the candidate focal length may be within a distance of the focal length 402. Therefore, the device 100 may determine a range of focal lengths centered at the candidate focal length (508), and the range of focal lengths may be used to determine a final focal length.

After the device 100 determines the range of focal lengths using the measured phase difference (504), the device 100 may determine the final focal length from the range of focal lengths (510). In some example implementations, the device 100 may move the camera lens within the range of focal lengths (512) and determine the focal length with the highest contrast (514). Moving the camera lens and measuring the contrast to determine the focal length with the highest contrast may be the same as for CDAF. For example, the device 100 may determine the final focal length within the range of focal lengths by using fine adjustments as described above regarding determining focal length 202 in FIG. 2. The device 100 may then set the camera lens 302 of camera 102 to the final focal length (not shown).

As described above, the resolution of measured light intensities (corresponding to the number of PDs) may affect the accuracy of a measured phase difference and determining a focal length. Another factor that may affect accuracy is the overall light intensity of the light measured by the PDs. For dark scenes with low levels of light being received by the camera sensor, the difference in light intensities (such as the difference in distributions in FIGS. 3A-3C) may be less pronounced (smaller height distributions) than for brighter scenes. As a result, larger errors may exist for measured phase differences of darker scenes than for measured phase differences of brighter scenes. Similarly, bright scenes (such as scenes with the reflected light causing the measured light intensities to be saturated, and as a result, differences in light intensity may be difficult to notice) may cause larger errors than darker scenes for measured phase differences. Additionally, the resolution of the measured light intensities may be affected by the size of the ROI. For example, a smaller ROI may have less associated PDs to measure light intensity than a larger ROI. While resolution and overall light intensity are provided as example factors affecting accuracy in measuring phase difference and determining a focal length using PDAF, other factors may exist, and the present disclosure should not be limited to any specific factors.

Since there may exist errors in a measured phase difference or determined candidate focal length, a confidence in the determined candidate focal length or measured phase difference may be determined. A higher confidence corresponds to less error or less probability for error in measuring phase difference or determining a focal length using PDAF. Conversely, a lower confidence corresponds to more error or more probability for error in measuring phase difference or determining a focal length using PDAF.

In some example implementations, the size of the range in focal lengths may be dependent on the confidence in the determined candidate focal length. For example, a smaller range may be used for a higher confidence than for a lower confidence. In some examples, the range of focal lengths may be indicated in terms of fine adjustments. For example, a fine adjustment may be a defined number of stops or a defined distance in moving the camera lens, and the range size may be a multiple of fine adjustments. A smaller range may allow for the device 100 to converge to a final focal length quicker than a larger range. For example, the number of fine adjustments performed in converging to the final focal length may decrease by as much as a decrease in range size since the maximum number of fine adjustments that may be performed for the range in determining the final focal length decreases.

In this manner, the range size may be inversely related to the number of PDs or the resolution of measured light intensity (since a decrease in PDs may increase the error for determined focal lengths). For example, the range size for a 2PD sensor may be 0 fine adjustments (if the determined candidate final focal length is to be used as the final focal length), the range size for a 2×1 sensor may be four fine adjustments, and the range size for sparser sensors than a 2×1 sensor (such as a 4×1 sensor) may be 8 fine adjustments centered at the candidate final focal length. As a result, more fine adjustments may occur in determining the final focal length when using sparser sensors.

In some example implementations, and in contrast to conventional AF operations, the device 100 may adjust the location and/or size of the ROI as a result of scene changes. For example, the device 100 may adjust the location and/or size of the ROI as a result of a moving object or face. In one example, if the camera 102 moves, a face or object for the ROI may move within the camera's field of capture. In another example, the face or object may move within the scene and therefore within the camera's field of capture. As a result, the device 100 may adjust the location and/or size of the ROI so that the ROI continues to include the moving face or object. The device 100 may adjust the ROI periodically (such as every image frame capture or other suitable period).

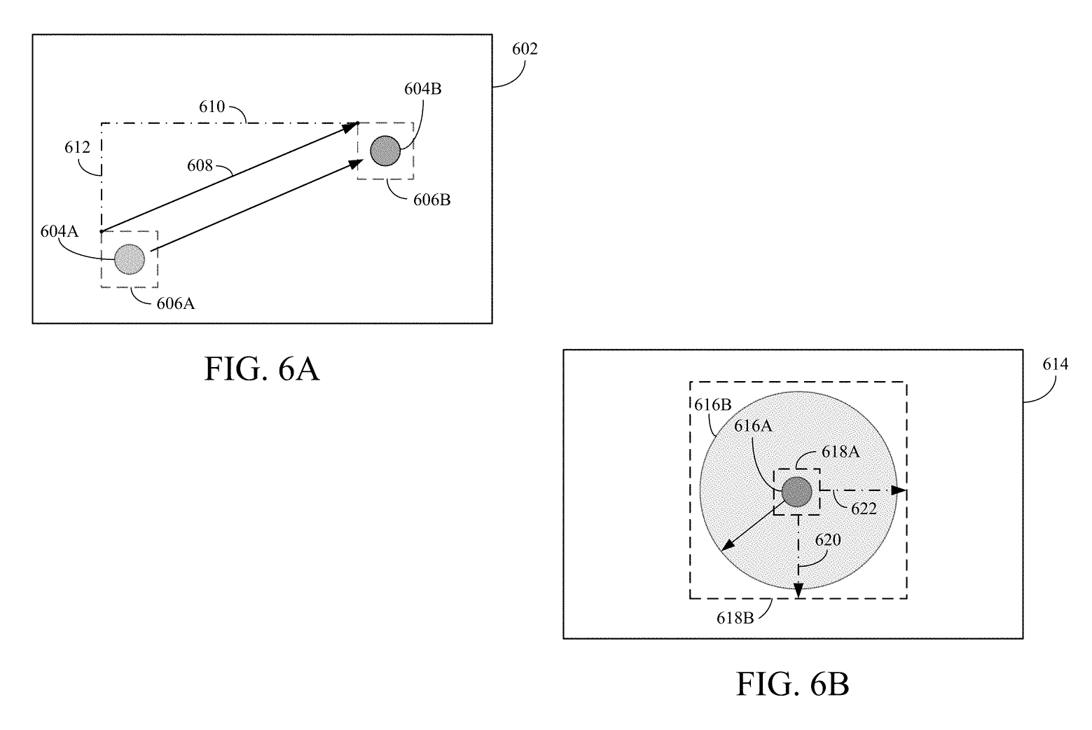

FIG. 6A is a depiction of an example change in location of an ROI. As shown, object 604A in a scene 602 captured by a camera may move to the location indicated by object 604B. The device 100 may therefore move the ROI 606A that includes the object 604A to the location indicated by ROI 606B. The device 100 may determine the change in location of the ROI, such as distance 608. Distance 608 may be determined in terms of a pixel distance, but any suitable measuring units may be used, such as a physical distance on the sensor, estimated physical distance between 606A and 606B, and so on. Alternatively or additionally, the device 100 may determine a horizontal distance 610 and a vertical distance 612 corresponding to the distance 608. In some example implementations, the device 100 measures the distance(s) from the top-left point or pixel of the ROI. For example, the device 100 may measure distance 608 and/or distances 610 and 612 from the top-left of ROI 606A to the top-left of ROI 606B.

In addition or alternative to an ROI changing location, the ROI may change (such as increase or decrease) in size. FIG. 6B is a depiction of an example size adjustment of an ROI. As shown, object 616A in a scene 614 captured by a camera may move closer to the camera and increase in size as indicated by object 616B. The device 100 may therefore resize the ROI 618A that includes the object 616A to the size indicated by ROI 618B. The device 100 may determine the change in size of the ROI, such as distance 620 and distance 622. The distances may be in terms of a pixel distance, but any suitable measuring units may be used, such as distance on the sensor. Alternatively, the device 100 may determine a change in width and height of the ROI (or determine an overall change in size of the ROI if the aspect ratio of the ROI remains the same) in terms of a ratio of the ROI (such as ROI 618A).

An example for determining a change in width from a previous ROI to a current ROI is depicted in equation (1) below:

$$Width change = \frac{\vert Current R O I width - Previous R O I width \vert}{min ( Current R O I width , Previous R O I width )} \qquad ( 1 )$$

Similarly, an example for determining a change in height from a previous ROI to a current ROI is depicted in equation (2) below:

$$Height change = \frac{\vert Current R O I height - Previous R O I height \vert}{min ( Current R O I height , Previous R O I height )} \qquad ( 2 )$$

The device 100 may measure a phase difference every frame capture, but the amount of time for determining a final focal length (such as determining a candidate and range and performing fine adjustments in the range) may be across multiple frame captures. In some example implementations, the ROI may need to be fixed or stable for determining the final focal length (similar to CDAF requiring a static ROI). Even if the ROI changes (such as the size and/or location of the ROI changes as described above), the device 100 may be able to measure a phase difference for the adjusted ROI each frame capture. However, the device 100 may not determine the final focal length when the ROI is changing as the final focal length may be different for the different instances of the ROI.

The device 100 may prevent determining the final focal length from the range of focal lengths until detecting that the ROI or object/face being tracked by the ROI is no longer changing (such as the camera 102 stops moving and/or the face or object for the ROI stops moving). In some example implementations, the device 100 may compare the determined distances in a location change of a ROI and/or the change in a size of a ROI for a current image frame and a previous image frame to determine/detect if the position and/or location of the object/face or ROI is no longer changing. For example, the device 100 may determine if a face/object is no longer changing in size or location in the field of capture by comparing measurements of the changes in the corresponding ROI to predetermined thresholds. If the difference in the location of the ROI between frames is greater than a location threshold and/or the difference in the size of the ROI between frames is greater than a size threshold, the device 100 may determine that the ROI is changing (and thus delay determining a final focal length).

A camera may shake or otherwise slightly move from involuntary hand movements, shifting between feet while standing, wind slightly pushing the camera, and so on. As a result, minor changes in size or location for the current ROI may exist, but the previous ROI may still be sufficient for determining a focal length during an AF operation. The device 100 may use one or more thresholds in analyzing the differences in the ROI to detect scene changes for the ROI (such as to determine if an object/face is moving in the camera's field of capture). For example, the device 100 may determine if the change in width of the ROI is greater than a first threshold, the change in height of the ROI is greater than a second threshold, the horizontal change in location of the ROI is greater than a third threshold, and/or the vertical change in location of the ROI is greater than a fourth threshold. In some example implementations, if any of the thresholds are exceeded, the device 100 may determine that the ROI is changing. If none of the thresholds are exceeded, the device 100 may determine that the face/object is stable (i.e., the corresponding ROI is not changing sufficiently to impact AF operations). In some other example implementations, a vote checker system may be used for determining if the face/object is stable. Otherwise, other suitable means for determining if the scene contents (such as a face/object) are stable may be used, and the present disclosure should not be limited to specific examples for determining if scene contents (such as a face/object) are stable.

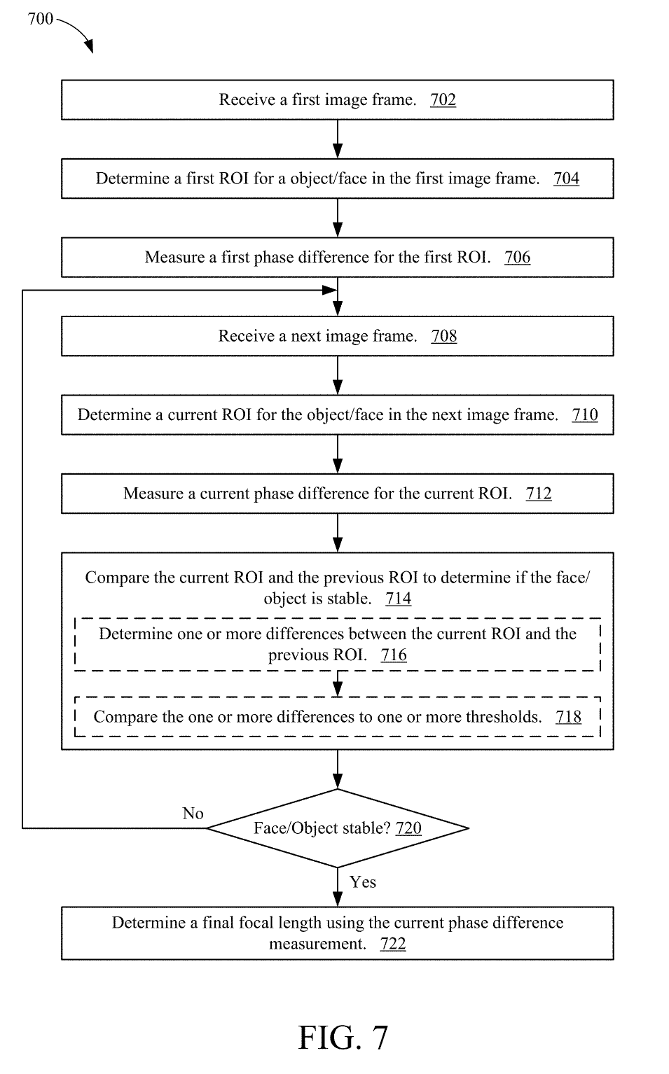

FIG. 7 is an illustrative flow chart depicting an example operation 700 for deciding when to determine a final focal length when an object or face is moving. Beginning at 702, the device 100 may receive a first image frame. For example, the camera 102 may capture an image frame, and provide the image frame to the camera controller 110 for processing. The device 100 may then determine a first ROI for a face/object in the first image frame (704). For example, the device 100 may identify a face in the image frame and determine a ROI for the identified face. After determining the first ROI (704), the device 100 may measure a phase difference for the first ROI (706).

The device 100 may also receive a next image frame (708). For example, after capturing a first image frame, the camera 102 may capture a next image frame at a frame capture rate (such as 6, 12, 24, or 30 frames per second, or another suitable frame rate), and provide the image frame to the camera controller 110. The device 100 may then determine a current ROI in the next image frame for the object/face from the first image frame (710), and measure a phase difference for the current ROI (712).

With a previous ROI and a current ROI determined, the device 100 may compare the current ROI and the previous ROI to determine if the face/object for the ROI is stable (714). In some example implementations, the device 100 may determine one or more differences between the current ROI and the previous ROI (716). For example, the device 100 may determine a change in width, a change in height, a change in horizontal location, and a change in vertical location between the current ROI and the previous ROI. The device 100 may then compare the one or more determined differences to one or more thresholds (718). For example, the device 100 may compare the change in width to a first threshold, the change in height to a second threshold, the change in horizontal location to a third threshold, and/or the change in vertical location to a fourth threshold. The thresholds may be fixed or configurable. For example, the device 100 may configure the thresholds based on, e.g., a size of the ROI, an overall light intensity, and/or another factor that may affect the confidence in the measured PD.

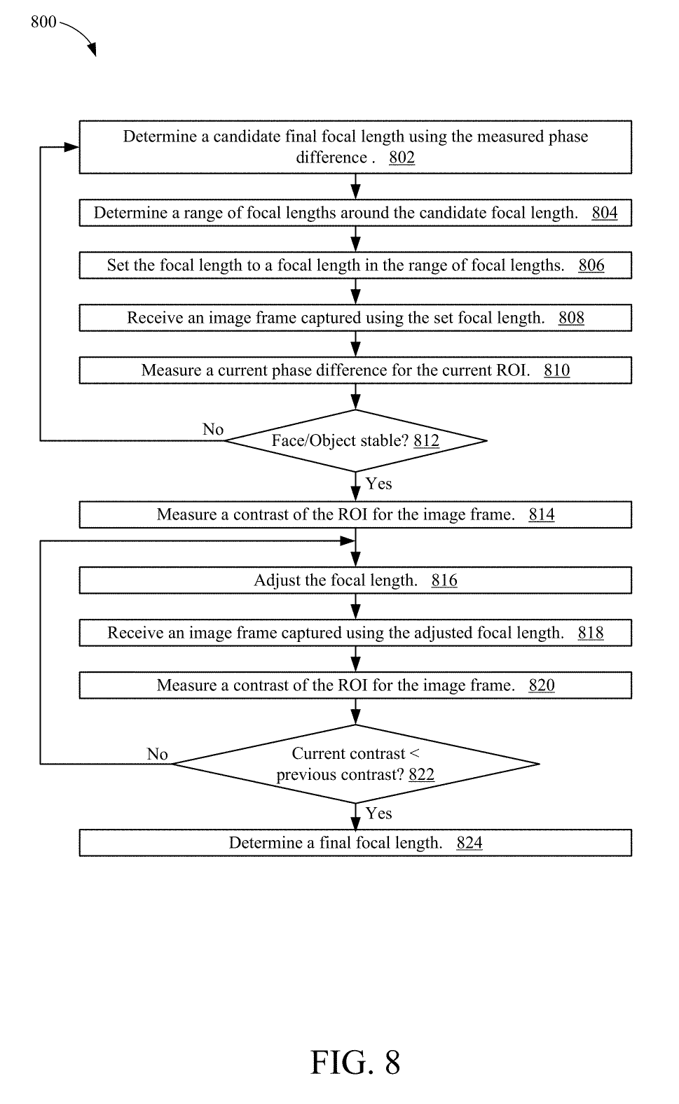

If the face/object is not stable (720), the device 100 receives a next image frame, with the process reverting to 708. The face/object may not be considered stable if any of the differences between the ROIs are greater than an associated threshold. However, other suitable means for determining if the face/object is stable may be used. If the face/object is stable (720), the device 100 may determine a final focal length using the current phase difference measurement (722). For a 2PD sensor, the device 100 may use the current phase difference measurement and the correlation between phase difference and focal length to determine a final focal length. For a sparser sensor (or in some example implementations for a 2PD sensor), the device 100 may determine a range of focal lengths and determine the final focal length from the range of focal lengths. FIG. 8 is an illustrative flow chart depicting an example operation 800 for determining a final focal length when the object or face is stable. Example operation 800 may be an example implementation of step 722 in FIG. 7.

Beginning at 802, the device 100 may determine a candidate final focal length using the measured phase difference. For example, the device 100 may use PDAF to determine a candidate final focal length from the measured phase difference. The device 100 may also determine a range of focal lengths around the candidate focal length (804). In some example implementations, the range size may be fixed. In some other example implementations, the range size may be configurable. In one example, a user may manually adjust the range size. In another example, the device 100 may automatically adjust the range size based on, e.g., the size of the ROI, the overall light intensity, and/or another factor that affects the confidence in the measured PD.

After determining the range of focal lengths, the device 100 may set the focal length for camera 102 to one of the focal lengths in the range of focal lengths (806). In some example implementations, the device 100 may set the focal length to the smallest focal length in the range of focal lengths. In some other example implementations, the device 100 may set the focal length to the candidate focal length (the center of the range of focal lengths). In some further example implementations, the starting focal length in the range of focal lengths is configurable. For example, the starting focal length may be set by a user. In another example, the device 100 may set the starting focal length based on the confidence in the measured phase difference and/or the candidate final focal length. For example, a higher confidence may cause the starting focal length to be closer to the candidate focal length, and a lower confidence may cause the starting focal length to be closer to the edge of the range of focal lengths.

After setting the focal length, the device 100 may receive an image frame captured using the set focal length (808). For example, the camera 102 may capture an image frame using the set focal length, and provide the captured image frame to the camera controller 110. The device 100 may then measure the phase difference for the current ROI of the new image frame (810) and determine whether the face or object is stable (812). Steps 810 and 812 may be similar to steps 712, 714, and 720 in FIG. 7 and described above. If the device 100 determines that the face or object is not yet stable (812), the device 100 may not perform CDAF. Instead, the device 100 again may determine a candidate final focal length using the current phase difference, with the process reverting to 802.

If the face or object is stable (812), the device 100 may then measure a contrast of the ROI for the image frame (814). In some example implementations, the ROI may be the ROI determined in step 710 in FIG. 7 (since the face/object is stable and the ROI is not significantly changing between image frames). After measuring the contrast, the device 100 may adjust the focal length (816). For example, the device 100 may perform a fine adjustment to the focal length. If the starting focal length is at the edge of the range, the fine adjustments to the focal length may be in one direction. If the starting focal length is not at the edge of the range, the fine adjustments to the focal length may be in either direction.

The device 100 may then receive an image frame captured using the adjusted focal length (818). For example, the camera 102 may capture an image frame using the adjusted focal length, and provide the captured image frame to the camera controller 110. After receiving the image frame, the device 100 may measure a contrast for the received image frame (820).

If the current contrast is greater than the previous contrast (822), the device 100 may perform another focal length adjustment within the range of focal lengths, with the process reverting to step 816. In some example implementations, the size of the adjustment may vary based on the difference between the current contrast and the previous contrast. For example, a larger difference may indicate that the focal length is further away from the final focal length than for a smaller difference. In this manner, the device 100 may configure the size of the focal length adjustment to more quickly converge to the focal length with the highest contrast (final focal length).

If the current contrast is less than the previous contrast (822), the device 100 may determine a final focal length (824). For example, if the contrast is increasing while the focal length is adjusted in one direction, and then the contrast decreases after the last focal length adjustment, the focal length with the greatest contrast (final focal length) may be the previous focal length or a focal length between the current focal length and the previous focal length. In this manner, the device 100 may determine the focal length with the largest contrast, similar to using fine adjustments for CDAF. In some other example implementations, the focal length may be adjusted in either direction. The device 100 may use any suitable manner in converging to a final focal length, and the present disclosure should not be limited to specific examples.

After determining a final focal length, the device 100 may set the camera lens 302 of camera 102 to the final focal length if not already set (not shown).

While the above examples are described regarding AF, some aspects of the present disclosure may be extended to any ROI tracking mechanism. In some example implementations, the device 100 may measure and use phase differences for a changing ROI across a sequence of images to attempt to keep the face or object approximately in focus. For example, if the depth of a face or object is changing between image frames, the device 100 may determine a candidate final focal length for each image frame and set the focal length of camera 102 to the candidate final focal length before the next image frame is captured. In another example, if determining and setting the focal length takes longer than one image capture, the device 100 may determine and set the focal length every n number of captures (where n is an integer greater than 1). While there may be a difference between the candidate final focal length and the final focal length for when the face or object is stable, the candidate final focal length may be closer than the previous focal length when the face or object is changing depths.

In some further examples, the device 100 may take into account vacillation in depth of the face or object. For example, the device 100 may store a plurality of previously measured phase differences and determine if the phase differences are increasing, decreasing, or vacillating. Additionally, the device 100 may determine if the vacillating depth is trending in a direction based on the stored phase differences. If the depth of a face or object is vacillating, the device 100 may adjust the candidate final focal length toward a center depth of the vacillation or may reduce the size of adjustment to the focal length. Any suitable means of compensating for face or object movement and adjusting the focal length may be used, and the present disclosure should not be limited to any of the specific examples provided.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 106 in the example device 100 of FIG. 1) comprising instructions 108 that, when executed by the processor 104 (or the camera controller 110 or the image signal processor 112), cause the device 100 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 104 or the image signal processor 112 in the example device 100 of FIG. 1. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. For example, the steps of the described example operations, if performed by the device 100, the camera controller 110, the processor 104, and/or the image signal processor 112, may be performed in any order and at any frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A device, comprising:
a memory; and
a processor coupled to the memory, the processor configured to:
receive a first image captured by a camera;
determine a first region of interest (ROI) for the first image;
receive a second image captured by the camera after capturing the first image;
determine a second ROI for the second image;
compare the first ROI and the second ROI; and
delay a determination of a final focal length based on the comparison of the first ROI and the second ROI.

2. The device of claim 1, wherein the processor is further configured to:
determine a phase difference for the second ROI; and
determine a first focal length based on the determined phase difference for the second ROI.

3. The device of claim 2, wherein the processor is further configured to:
instruct the camera to set its focal length to the first focal length; and
receive a third image captured by the camera with the first focal length.

4. The device of claim 3, wherein the processor, in comparing the first ROI and the second ROI, is configured to perform at least one from the group consisting of:
determining a size difference between a size of the first ROI and a size of the second ROI; and
determining a location difference between a location in the first image of the first ROI and a location in the second image of the second ROI.

5. The device of claim 4, wherein, when the size difference is greater than a size threshold or the location difference is greater than a location threshold, the processor is further configured to:
determine a third ROI for the third image;
determine a phase difference for the third ROI;
determine a second focal length based on the determined phase difference for the third ROI; and
instruct the camera to set its focal length to the second focal length.

6. The device of claim 4, wherein, when the size difference is less than a size threshold if the size difference is determined and the location difference is less than a location threshold if the location difference is determined, the processor is further configured to:
determine a range of focal lengths for the final focal length, wherein the range of focal lengths includes the first focal length;
determine a contrast for each of one or more images captured by the camera at one or more focal lengths in the range of focal lengths, wherein:
the one or more focal lengths includes the first focal length; and
each contrast is for a region of the respective image, the region corresponding to the second ROI in the second image; and
determine the final focal length based on the one or more contrasts.

7. The device of claim 6, wherein the processor is further configured to:
determine a confidence in the phase difference for the second ROI, wherein at least one from the group consisting of a size and a location of the range of focal lengths is based on the confidence.

8. The device of claim 2, further comprising a camera to capture the first image and the second image, the camera including a sensor to measure instances of light reflected from an object in a scene captured by the camera, wherein the phase difference is a distance between instances of light measured by the sensor.

9. A method, comprising:
receiving a first image captured by a camera;
determining a first region of interest (ROI) for the first image;
receiving a second image captured by the camera after capturing the first image;
determining a second ROI for the second image;
comparing the first ROI and the second ROI; and
delaying a determination of a final focal length based on the comparison of the first ROI and the second ROI.

10. The method of claim 9, further comprising:
determining a phase difference for the second ROI; and
determining a first focal length based on the determined phase difference for the second ROI.

11. The method of claim 10, further comprising:
instructing the camera to set its focal length to the first focal length; and
receiving a third image captured by the camera with the first focal length.

12. The method of claim 11, wherein comparing the first ROI and the second ROI comprises at least one from the group consisting of:
determining a size difference between a size of the first ROI and a size of the second ROI; and
determining a location difference between a location in the first image of the first ROI and a location in the second image of the second ROI.

13. The method of claim 12, further comprising, when the size difference is greater than a size threshold or the location difference is greater than a location threshold:
determining a third ROI for the third image;
determining a phase difference for the third ROI;
determining a second focal length based on the determined phase difference for the third ROI; and
instructing the camera to set its focal length to the second focal length.

14. The method of claim 12, further comprising, when the size difference is less than a size threshold if the size difference is determined and the location difference is less than a location threshold if the location difference is determined:
determining a range of focal lengths for the final focal length, wherein the range of focal lengths includes the first focal length;
determining a contrast for each of one or more images captured by the camera at one or more focal lengths in the range of focal lengths, wherein:
the one or more focal lengths includes the first focal length; and
each contrast is for a region of the respective image, the region corresponding to the second ROI in the second image; and
determining the final focal length based on the one or more contrasts.

15. The method of claim 14, further comprising:
determining a confidence in the phase difference for the second ROI, wherein at least one from the group consisting of a size and a location of the range of focal lengths is based on the confidence.

16. A non-transitory computer-readable medium storing one or more programs containing instructions that, when executed by one or more processors of a device, cause the device to perform operations comprising:
receiving a first image captured by a camera;
determining a first region of interest (ROI) for the first image;
receiving a second image captured by the camera after capturing the first image;
determining a second ROI for the second image;
comparing the first ROI and the second ROI; and
delaying a determination of a final focal length based on the comparison of the first ROI and the second ROI.

17. The computer-readable medium of claim 16, wherein the instructions cause the device to perform operations further comprising:
determining a phase difference for the second ROI; and
determining a first focal length based on the determined phase difference for the second ROI.

18. The computer-readable medium of claim 17, wherein the instructions cause the device to perform operations further comprising:
instructing the camera to set its focal length to the first focal length; and
receiving a third image captured by the camera with the first focal length.

19. The computer-readable medium of claim 18, wherein comparing the first ROI and the second ROI includes at least one from the group consisting of:
determining a size difference between a size of the first ROI and a size of the second ROI; and
determining a location difference between a location in the first image of the first ROI and a location in the second image of the second ROI.

20. The computer-readable medium of claim 19, wherein the instructions cause the device to perform operations further comprising, when the size difference is greater than a size threshold or the location difference is greater than a location threshold:
determining a third ROI for the third image;
determining a phase difference for the third ROI;
determining a second focal length based on the determined phase difference for the third ROI; and
instructing the camera to set its focal length to the second focal length.

21. The computer-readable medium of claim 19, wherein the instructions cause the device to perform operations further comprising, when the size difference is less than a size threshold if the size difference is determined and the location difference is less than a location threshold if the location difference is determined:
determining a range of focal lengths for the final focal length, wherein the range of focal lengths includes the first focal length;
determining a contrast for each of one or more images captured by the camera at one or more focal lengths in the range of focal lengths, wherein:
the one or more focal lengths includes the first focal length; and
each contrast is for a region of the respective image, the region corresponding to the second ROI in the second image; and
determining the final focal length based on the one or more contrasts.

22. The computer-readable medium of claim 21, wherein the instructions cause the device to perform operations further comprising:
determining a confidence in the phase difference for the second ROI, wherein at least one from the group consisting of a size and a location of the range of focal lengths is based on the confidence.

23. A device, comprising:
means for receiving a first image captured by a camera;
means for determining a first region of interest (ROI) for the first image;
means for receiving a second image captured by the camera after capturing the first image;
means for determining a second ROI for the second image;
means for comparing the first ROI and the second ROI; and
means for delaying a determination of a final focal length based on the comparison of the first ROI and the second ROI.

24. The device of claim 23, further comprising:
means for determining a phase difference for the second ROI; and
means for determining a first focal length based on the determined phase difference for the second ROI.

25. The device of claim 24, further comprising:
means for instructing the camera to set its focal length to the first focal length; and
means for receiving a third image captured by the camera with the first focal length.

26. The device of claim 25, wherein comparing the first ROI and the second ROI includes at least one from the group consisting of:
determining a size difference between a size of the first ROI and a size of the second ROI; and
determining a location difference between a location in the first image of the first ROI and a location in the second image of the second ROI.

27. The device of claim 26, further comprising, when the size difference is greater than a size threshold or the location difference is greater than a location threshold:
means for determining a third ROI for the third image;
means for determining a phase difference for the third ROI;
means for determining a second focal length based on the determined phase difference for the third ROI; and
means for instructing the camera to set its focal length to the second focal length.

28. The device of claim 26, further comprising, when the size difference is less than a size threshold if the size difference is determined and the location difference is less than a location threshold if the location difference is determined:
means for determining a range of focal lengths for the final focal length, wherein the range of focal lengths includes the first focal length;
means for determining a contrast for each of one or more images captured by the camera at one or more focal lengths in the range of focal lengths, wherein:
the one or more focal lengths includes the first focal length; and
each contrast is for a region of the respective image, the region corresponding to the second ROI in the second image; and
means for determining the final focal length based on the one or more contrasts.

29. The device of claim 28, further comprising:
means for determining a confidence in the phase difference for the second ROI, wherein at least one from the group consisting of a size and a location of the range of focal lengths is based on the confidence.

30. The device of claim 24, further comprising:
means for measuring instances of light reflected from an object in a scene captured by the camera, wherein the phase difference is a distance between instances of light measured.
